(19) United States
(12) Patent Application Publication
(10) Pub. No.: US 2008/0053608 A1
(43) Pub. Date: Mar. 6, 2008

(54) TWO-PLY PRE-PRINTED RIGID THERMOFORMABLE MATERIAL

(75) Inventors: Timothy J. Wald, Sioux Falls, SD (US); Robert E. Baum, Dell Rapids, SD (US); Donald P. Klein, Dell Rapids, SD (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CCL LABEL, INC., Sioux Falls, SD (US)

(21) Appl. No.: 11/468,936

(22) Filed: Aug. 31, 2006

(51) Int. Cl. B32B 37/00

(52) U.S. Cl. 156/277; 428/542.8

(57) ABSTRACT

A pre-printed rigid thermoformable material suitable for use in manufacturing consumer retail packaging. The material includes two rigid thermoformable layers or films adhered together. Printing is included on either or both of the facing surfaces of the films, so that the printing is protected between the adhered layers.

### BACKGROUND OF THE INVENTION

The present invention relates to materials used for producing consumer packaging, and more particularly to multiple-ply, pre-printed, thermoformable materials used for producing consumer packaging.

Thermoformable materials are widely used in the production of consumer packaging. Exemplary applications include personal care products (e.g. razors and razor blades) and electronic products (e.g. MP3 players and computer add-ons). To manufacture such packaging, the thermoformable material is first fabricated in web or sheet form; and the material is second thermoformed (or otherwise molded) into the desired shape. Printing is included on the thermoformable material so that the ultimate packaging has a desired appearance.

One prior art thermoformable material is a sandwich of two plies, namely a rigid thermoformable film and a flexible film. The flexible film is printed and then adhered to the thermoformable film to produce the sandwich. The flexible film is relatively thin and flexible, and therefore relatively easily printed. The rigid thermoformable film enables the sandwich to retain its shape following the thermoforming.

Unfortunately, the known sandwich material has at least two disadvantages. First, the two films in the sandwich have different physical properties and therefore present adhesion challenges. For example, an adhesive that is effective for one film may not be effective for the other film. Second, the different layers respond differently to the temperatures required for thermoforming. For example, one film might have a higher shrinkage rate than the other, causing the films to pull on one another during thermoforming.

### SUMMARY OF THE INVENTION

The aforementioned problems are overcome in the present invention in which a multiple-ply, pre-printed, rigid thermoformable material is fabricated of two or more rigid thermoformable films or layers laminated together. Printing is included on at least one of the facing surfaces of the thermoformable films so that the printing is protected between the two films.

The present invention includes at least two advantages over prior art materials. First, the two films are relatively easily and consistently adhered together because they both are rigid thermoformable materials. Second, the two films behave similarly in the subsequent thermoforming operation again because they both are rigid thermoformable materials.

These and other objects, advantages, and features will be more fully understood and appreciated by reference to the description of the current embodiment and the drawings.

### BRIEF DESCRIPTION OF THE DRAWINGS

FIG. 1 is a perspective view, partially broken away on the right side, showing the rigid thermoformable material of the present invention; and

FIG. 2 is a perspective view of a consumer package fabricated using the material.

### DESCRIPTION OF THE CURRENT EMBODIMENT

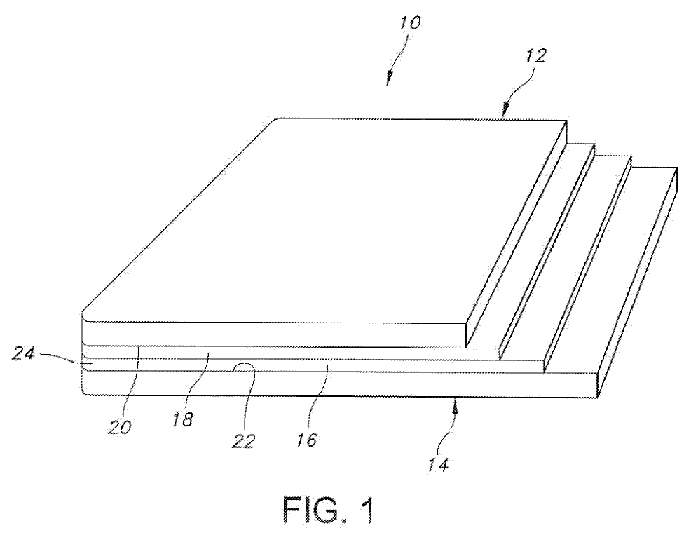

A pre-printed rigid thermoformable material or sandwich fabricated in accordance with the current embodiment of the invention is illustrated in FIG. 1 and generally designated 10. The material or sandwich includes two rigid thermoformable films 12 and 14 laminated together by an adhesive 16. Printing 18 is included on at least one of the inside surfaces of the films 12 and 14.

Each of the rigid thermoformable films 12 and 14 can be any of a wide variety of materials known to those skilled in the art. In the current embodiment, each film is a polyvinylchloride (PVC) material. Other suitable materials include, but are not limited to, polyethylene terephthalate glycol (PETG), amorphous polyethylene terephthalate (APET), recycled polyethylene terephthalate (RPET), polypropylene (PP), or oriented polystyrene (OPS).

In the current embodiment, each film is approximately 8 mils (0.008 inch) thick. Other suitable thicknesses may be used, and the thickness will depend on the material, the ultimate packaging application, and other considerations. It is anticipated that materials up to 30 mils thick could be handled and printed on currently available printing equipment. In the current embodiment, the two films 12 and 14 each have a uniform thickness. However, such uniformity is not required. The layers may be of different thicknesses depending on the particular application and considerations in the subsequent thermoforming operation. If the layers are of different thicknesses, the printing 18 typically would be applied to the thinner layer because the thinner layer typically can be more easily printed. However, the printing as noted above may be included on any or all of the four surfaces of the two films.

Currently, at least one of the films is transparent or translucent so that the printing 18 may be viewed through that film. The degree of opacity and/or transparency of the films 12 and 14 will depend, among other factors, on the desired visual effect in combination with the printing 18.

The printing 18 is included on the inside surface 20 of the upper film 12. The printing can be any suitable process known to those skilled in the art. Suitable processes include, but are not limited to, gravure, flexo, digital, screen, and offset. The printing 18 preferably is sufficiently flexible so that, when the sandwich 10 is subsequently thermoformed, the printing will not chip or crack.

Although the printing 18 is illustrated as being on the inside surface 20 of the top film 12, additional printing may be on any or all of (a) the two surfaces of the upper film 12 and (b) the two surfaces of the lower film 14. When the printing is located on one of the facing inside surfaces 20 or 22, then the printing will be protected from scratching or marring during subsequent handling and thermoforming.

The printing 18 as illustrated in FIG. 1 is a continuous and uniform layer. That layer is intended to represent any printing in any pattern using any inks. For example, the printing likely would be non-continuous to form graphics, characters, numbers, background, or other desired presentations and effects.

The two film layers 12 and 14 are adhered together by a laminated adhesive 24. Presently, the laminating adhesive is a solvent-based urethane. Alternative adhesives will be known to those in the art and will depend on the particular material or materials of which the rigid thermoformable films 12 and 14 are fabricated. For example, one currently anticipated alternative adhesive is the solvent-based adhesive sold under the trademark PERMUTHANE™ by Stahl. Other currently anticipated alternative adhesives include gravure laminating adhesives, ultraviolet (UV) laminating adhesives, and electronic beam (EB) adhesives.

Suitable manufacturing techniques for producing the sandwich 10 are known to those in the art. Typically, the films 12 and 14 are continuous webs and the resulting sandwich 10 also is a continuous web. Alternatively, the sandwich 10 can be fabricated in sheet form, in which case the beginning films 12 and 14 could be either continuous or sheet form themselves. Printing 18 is applied to the desired surfaces of the films 12 and 14. Any printing on the facing inside layers 20 and 22 is applied before the films are adhered together. Printing on the exposed surfaces may be applied either before or after the films are adhered together.

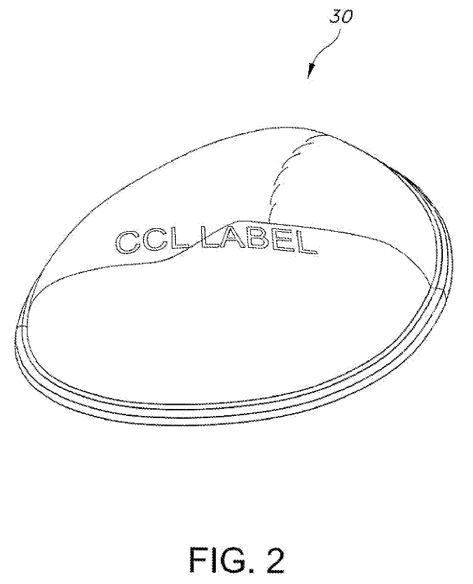

The material 10 is used in subsequent thermoforming operations, which do not form part of the present invention, to produce packaging article for consumer or other products. One exemplary article 30 is illustrated in FIG. 2. The article has been thermoformed by placing the planar sandwich 10 into a thermoforming machine, applying heat to deform the planar sandwich to a desired shape, cooling the material, and removing the article from the thermoforming equipment. Once formed, the article retains its shape as illustrated in FIG. 2. The printing 18 will deform with the films 12 and 14 so that the printing provides a desired appearance through the films. However, as noted above, the printing material and process is selected so that the printing does not chip or crack during the thermoforming operation.

The above description is that of a current embodiment of the invention. Various alterations and changes can be made without departing from the spirit and broader aspects of the invention as defined in appended claims, which are to be interpreted in accordance with the principles of patent law, including the doctrine of equivalents.

The embodiments of the invention in which an exclusive property or privilege is claimed are defined as follows:

1. A thermoformable material comprising:
a first layer of thermoformable material having a first inside surface and a first outside surface;
a second layer of thermoformable material having a second inside surface and a second outside surface;
printing on at least one of said first and second inside surfaces; and
adhesive means for adhering said first and second layers together with said inside surfaces facing one another, whereby said printing is protected between said first and second layers.

2. A thermoformable material as defined in claim 1 wherein said first and second layers are fabricated of the same material.

3. A thermoformable material as defined in claim 1 wherein said first and second layers are essentially the same thickness.

4. A thermoformable material as defined in claim 1 further comprising additional printing on the other of said first and second inside surfaces.

5. A thermoformable material as defined in claim 1 further comprising additional printing on at least one of said first and second outside surfaces.

6. A thermoformable material as defined in claim 1 wherein said adhesive means comprises a solvent-based adhesive.

7. A method of manufacturing a rigid thermoformable material comprising:
printing on a first inside surface of a first rigid thermoformable layer; and
adhering the first rigid formable layer to a second rigid thermoformable layer with the first inside surface facing the second layer, whereby said printing is protected between the first and second layers.

8. A method as defined in claim 7 wherein the first and second layers are fabricated of the same material.

9. A method as defined in claim 7 wherein the first and second layers are essentially the same thickness.

10. A method as defined in claim 7 further comprising printing on a second inside surface of the second layer, the second surface facing the first layer.

11. A method as defined in claim 7 further comprising printing on at least one of a first outside surface of the first layer and a second outside surface of the second layer.

12. A method as defined in claim 7 wherein said adhering step comprises using a solvent-based adhesive.
